(19) United States
(12) Patent Application Publication
(10) Pub. No.: US 2026/0278150 A1
(43) Pub. Date: Sep. 17, 2026

(54) GENERATING SYNTHETIC DATASETS USING PATTERN SELECTION

(71) Applicant: Google LLC, Mountain View, CA (US)

(72) Inventors: Deepansha Singh, Los Angeles, CA (US); Alex Ryutov, Porter Ranch, CA (US); Aleksandr Knop, Brooklyn, NY (US); Bradford Dylan Threatt, Mableton, GA (US); Scott David Schneider, Burbank, CA (US)

(21) Appl. No.: 19/438,299

(22) Filed: Dec. 31, 2025

(30) Foreign Application Priority Data
Mar. 12, 2025 (IN) 202511022143

(51) Int. Cl. G06F 21/62

(52) U.S. Cl. CPC G06F 21/6227

(57) ABSTRACT

Methods, systems, and apparatus, including computer programs encoded on a computer storage medium, for generating synthetic datasets. In one aspect, a method includes receiving, from a data consumer, a dataset and one or more patterns. Each pattern defines statistical information characterizing at least a portion of data in the dataset. A search space that includes a set of candidate patterns is identified based on the dataset. A selection is made, using the dataset and the one or more patterns, from the set of candidate patterns, a proper subset of the candidate patterns to be used in generating a synthetic dataset. A differentially private synthetic dataset is generated based on the subset of patterns.

### CROSS-REFERENCE TO RELATED APPLICATIONS

This application claims priority to I.N. Application Serial No. 202511022143, filed on Mar. 12, 2025. The disclosure of the prior application is considered part of the disclosure of this application, and is incorporated in its entirety into this application.

### BACKGROUND

This specification relates to data security, data privacy, and generating synthetic datasets using differential privacy techniques.

### SUMMARY

This specification describes techniques for generating a synthetic dataset based on an original dataset that preserves particular patterns of the original dataset. A pattern can define statistical information that characterizes at least a portion of data in a dataset and/or define a relationship between multiple attributes within the dataset. The techniques can involve receiving, by a system, an original dataset and one or more patterns from a data consumer. The system can use domain knowledge related to a domain associated with the original dataset to select a proper subset of patterns from a search space of candidate patterns. The search space of candidate patterns includes a set of candidate patterns to be incorporated into a synthetic dataset that is to be generated based on the original dataset.

The system can use the domain knowledge to inform various criteria that it will use to select the proper subset of the candidate patterns. For example, the criteria can include a likelihood that incorporation of a pattern into the synthetic dataset produces an error in a response to a query for information about the original dataset, or the relevance of a pattern to the domain, or both.

In some implementations, the system can generate the synthetic dataset using the selected subset of patterns. For example, the system can generate a latent variable that characterizes one or more of the patterns of the subset and add differential privacy noise to the latent variable. The system can then generate the synthetic dataset such that the distribution of the latent variable in the synthetic dataset is similar to the distribution of the latent variable with added differential privacy noise.

The techniques can also involve using the synthetic dataset to generate responses to queries for information related to the original dataset. The data of the synthetic dataset can be differentially private such that the data consumer querying the data is prevented from learning information about individuals for which data is included in the dataset.

In general, one innovative aspect of the subject matter described in this specification can be embodied in methods that include the actions of receiving, from a data consumer, a dataset and one or more patterns, wherein each pattern defines statistical information characterizing at least a portion of data in the dataset; identifying, based on the dataset, a search space comprising a set of candidate patterns; selecting, using the dataset and the one or more patterns, from the set of candidate patterns, a proper subset of the candidate patterns to be used in generating a synthetic dataset; and generating a differentially private synthetic dataset based on the subset of patterns. Other implementations of this aspect include corresponding apparatus, systems, and computer programs, configured to perform the aspects of the methods, encoded on computer storage devices.

These and other embodiments can each optionally include one or more of the following features. In some aspects, generating the differentially private synthetic dataset based on the subset of patterns includes adding differential privacy noise to a latent variable that characterizes one or more patterns of the subset of patterns.

Some aspects include receiving, from the data consumer, a query for information related to the dataset; generating a response to the query using data of the synthetic dataset; and providing, to the data consumer, the response to the query.

Some aspects include identifying additional patterns not included in the set of candidate patterns using the dataset. Generating the synthetic dataset based on the subset of patterns can include generating the synthetic dataset based on the additional patterns.

In some aspects, selecting, from the set of candidate patterns, a proper subset of the candidate patterns using the dataset and the one or more patterns includes selecting the proper subset of the candidate patterns using a likelihood that incorporation of one or more patterns of the set of candidate patterns into the synthetic data set produces an error in a response to a query of the synthetic dataset.

In some aspects, selecting, from the set of candidate patterns, a proper subset of the candidate patterns using the dataset and the one or more patterns includes selecting the proper subset of patterns using domain knowledge related to a domain associated with the dataset.

In some aspects, selecting, from the set of candidate patterns, a proper subset of the candidate patterns using the dataset and the one or more patterns includes providing information related to a proposed subset of patterns to the data consumer; receiving feedback on the information from the data consumer; and selecting the proper subset of the candidate patterns using the feedback.

In some aspects, selecting, from the set of candidate patterns, a proper subset of the candidate patterns using the dataset and the one or more patterns includes assigning to each of one or more patterns in the set of candidate patterns a respective weight based on the set of criteria; and selecting the proper subset of the candidate patterns using the respective weights.

Particular embodiments of the subject matter described in this specification can be implemented so as to realize one or more of the following advantages. The techniques described in this specification provide for reducing the size of a search space including a set of candidate patterns to be incorporated into a synthetic dataset. The techniques involve selecting a proper subset of the set of candidate patterns based on various criteria including the relevance of the patterns to a domain associated with the original dataset and a likelihood that incorporation of the patterns into the synthetic dataset produces an error in a response to a query.

Reducing the size of the search space in this way can save computational resources that are otherwise consumed in existing techniques for generating synthetic datasets. For example, some existing techniques generate synthetic datasets by considering all of the candidate patterns in the search space for incorporation into the synthetic dataset. However, one or more of the candidate patterns in the search space may not be appropriate for the domain associated with the dataset, e.g., incorporation of such patterns into a synthetic dataset to be used in the domain would result in a synthetic dataset that does not perform well in the domain. The performance can be measured based on the amount of error in the differentially private data. Thus, generating synthetic datasets that incorporate such patterns may waste computational resources. By selecting a proper subset of the candidate patterns included in the search space and incorporating only patterns included in the proper subset into the generated synthetic dataset, the techniques described in this specification reduce the quantity of computational resources expended in generating synthetic datasets as compared to those expended using those existing techniques.

The techniques described in this specification provide for the generation of synthetic datasets that incorporate patterns that are selected based on domain knowledge related to a domain associated with the original dataset. For example, the techniques involve using the domain knowledge to generate additional patterns that are likely to be relevant to the domain and the incorporation of the additional patterns into the generated synthetic dataset. The techniques can include assigning weights to candidate patterns based at least in part on the domain knowledge. The weight assigned to a candidate pattern can represent a measure of the relevance of the pattern to the domain associated with the dataset. The techniques involve selecting patterns to be incorporated into the generated synthetic dataset using the assigned weights.

In this way, the techniques can increase a likelihood that the patterns incorporated into the generated synthetic dataset are relevant to the domain associated with the original dataset, according to the domain knowledge related to the domain. This can improve the responses to queries generated by a system that uses the synthetic dataset to generate the response. For example, queries for information related to a dataset are more likely to relate to patterns in the dataset that are relevant to the domain associated with the dataset. Thus, if the synthetic dataset used to generate responses to queries incorporates these relevant patterns, the responses are more likely to capture the information for which the queries are made. Additionally, assigning weights to patterns that depend on their relevance to the original dataset can reduce a likelihood that computational resources are wasted by generating synthetic datasets that incorporate irrelevant patterns.

The techniques described in this specification provide for the generation of synthetic datasets that incorporate patterns that are selected based on likelihoods that incorporation of the patterns into the synthetic dataset produces an error in a response to a query. The techniques can include using an error computer to compute these likelihoods and selecting patterns to be incorporated into the generated synthetic dataset using the likelihoods, e.g., by selecting patterns that have lower likelihoods relative to unselected patterns.

In this way, the techniques can increase a likelihood that the patterns incorporated into the generated synthetic dataset do not produce errors, or at least reduces the number and/or significance of errors, in responses to queries related to the original dataset. This can enhance the quality of responses to queries generated by a system using the synthetic dataset, e.g., by increasing the level of accuracy of the responses to the queries. Additionally, selecting patterns using the likelihoods can reduce a likelihood that computational resources are wasted by generating synthetic datasets that incorporate patterns likely to result in errors in responses to queries.

The techniques described in this specification can provide for the generation of synthetic datasets that incorporate patterns based on feedback from a data consumer. The techniques can include adjusting a proposed set of patterns to be incorporated into a generated synthetic dataset using feedback provided by a data consumer about the proposed set of patterns. The techniques involve generating the synthetic dataset using the proposed set of patterns that has been adjusted using the feedback.

The generation of synthetic datasets using feedback from a data consumer can enhance the efficiency of synthetic dataset generation as compared to existing methods, e.g., by saving time and computational resources that are otherwise required by existing methods. Some existing methods can generate synthetic datasets that incorporate patterns that are not of interest to a data consumer that will query the synthetic dataset, and that fail to incorporate other patterns that are of interest to the data consumer. Time or computational resources, or both, can unnecessarily be consumed in incorporating into the synthetic dataset the patterns that are not of interest to the data consumer. Additional waste of time or computational resources, or both, can be incurred in generating subsequent one or more synthetic datasets that incorporate patterns that are of interest to the data consumer, e.g., to correct or improve upon an initial synthetic dataset that did not incorporate such patterns. Thus, in using feedback from a data consumer in the generation of a synthetic dataset, the techniques described in this specification can save time and computational resources. Additionally, these techniques can enhance the quality of responses to queries that are generated by a system that uses a synthetic dataset that was generated using feedback from a data consumer.

These techniques can also enhance the quality of queries that are developed using synthetic datasets generated using feedback from a data consumer. For example, a data consumer can use a synthetic dataset to test a particular query that the data consumer is developing for querying a real dataset. The data consumer can query the synthetic dataset with the particular query and adjust the particular query based on the results of querying the synthetic dataset with the particular query. The data consumer can repeat this process of querying the synthetic dataset and adjusting the particular query for any desired number of times, e.g., until the data consumer feels that the particular query is ready to be used for querying the real dataset. This process can help to preserve the privacy of data included in the real dataset by limiting the number of times the real dataset is queried, since the data consumer queries only the synthetic dataset while developing the particular query.

In such circumstances, if the synthetic dataset has been generated to incorporate patterns based on feedback from the data consumer, e.g., using the techniques described herein, the data consumer can develop the particular query with increased efficiency, as compared to if the synthetic dataset does not incorporate patterns based on the feedback. For example, the data consumer can provide feedback that results in the generation of a synthetic dataset that incorporates patterns that are likely to be useful to the data consumer in developing the particular query. Thus, the results of querying the synthetic dataset to develop the particular query are more likely to be useful in developing the particular query. These improved results can increase the efficiency with which the particular query is developed, e.g., by reducing the number of times the data consumer needs to query the synthetic dataset in developing the particular query, or by improving the adjustments made to the particular query based on the results of querying the synthetic dataset.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which synthetic datasets are generated and queried.

FIG. 2 is a flow diagram of an example process for selecting patterns to be used in generating synthetic datasets.

FIG. 3 is a flow diagram of an example process for responding to queries using synthetic datasets.

FIG. 4 is a block diagram of an example computer system.

Like reference numbers and designations in the various drawings indicate like elements.

### DETAILED DESCRIPTION

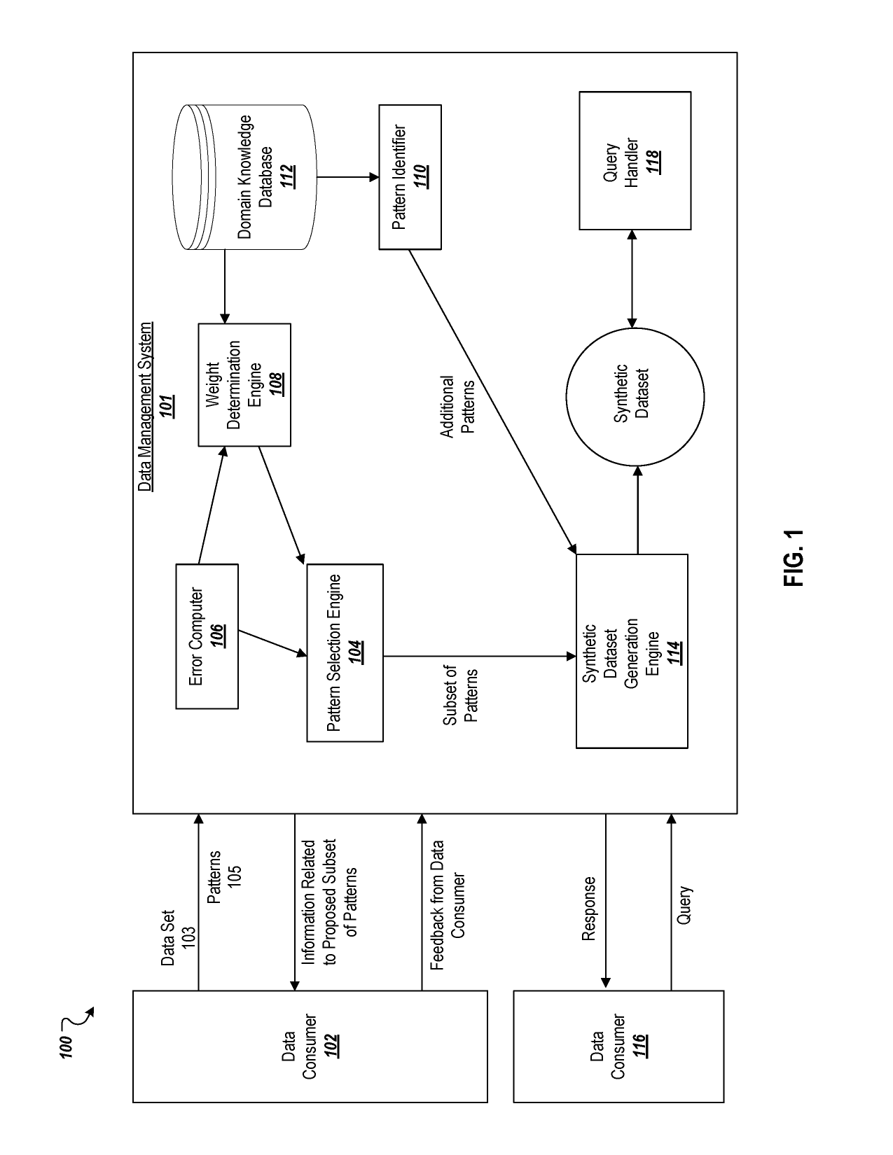

FIG. 1 is an example environment 100 in which synthetic datasets are generated and queried. The synthetic datasets can be generated by a data management system 101. The data management system 101 is an example of a system implemented as computer programs on one or more computers in one or more locations, in which the systems, components, and techniques described below can be implemented.

The environment 100 also includes a data consumer 102 and a data consumer 116. The data consumer 116 can be the same data consumer as the data consumer 102, or can be a different data consumer. The data consumers 102 and 116 interact with the data management system 101, e.g., by sending and receiving data to and from the data management system 101. The data consumers 102 and 116 can interact with the data management system 101 by sending to the data management system 101 queries for information related to the dataset 103, and receiving from the data management system 101 responses to the queries. The data consumers 102 and 116 can interact with the data management system 101 via a network.

The data management system 101 includes a pattern selection engine 104, an error computer 106, a weight determination engine 108, a pattern identifier 110, a domain knowledge database 112, a synthetic dataset generation engine 114, and a query handler 118.

The pattern selection engine 104 can be configured to receive information from the error computer 106, the weight determination engine 108, and/or the pattern identifier 110. The pattern selection engine 104 can be configured to process the received information, a dataset received by the data management system 101, and one or more patterns received by the data management system 101. The pattern selection engine 104 can be configured to select a subset of patterns from a search space of candidate patterns in response to processing the information, the dataset, and the one or more patterns.

A pattern can define statistical information that characterizes at least a portion of data in a dataset and/or define a relationship between multiple attributes within the dataset. For example, a pattern can be a statistic that is computed based on one or more types of data in the dataset. In another example, a pattern can by a relationship between two or more attributes or types of data. When generating a synthetic dataset, these patterns can be preserved such that the relevant statistics can be determined from the data of the synthetic datasets, as described below.

The data management system 101 receives from the data consumer 102 a dataset 103 and one or more received patterns 105. The dataset 103 can include information about one or more items, each item having one or more attributes. For example, an item can be an individual, a consumer product, an entity, a transaction, a financial instrument, a device, an interaction between two entities, or any other item of interest. An attribute of an item can be a datum representing a feature of the item. For example, if the dataset includes information about individuals, attributes of each individual can include the age of the individual, a physical feature of the individual, or an action taken by the individual.

The dataset 103 can be associated with a domain. A domain with which a dataset can be associated can be a context in which the information included in the dataset will be used. For example, a dataset might include demographic information about individuals to be used in analyzing voting trends among individuals. The domain of the dataset can then be the analysis of voting trends of individuals. A dataset might include information about financial transactions that have been conducted on a stock exchange to be used for predicting stock market trends. The domain of the dataset can then be the prediction of stock market trends.

Other domains can include the analysis of digital component distribution (e.g., advertisements), the analysis of census data, or the analysis of medical information.

The data management system 101 can maintain domain knowledge related to the domain with which the dataset 103 is associated on the domain knowledge database 112. Domain knowledge can be information related to a domain associated with a dataset. This information can include historical information related to events that have occurred in the domain. The information can include trends related to events that occur in the domain. For example, if the domain is the analysis of digital component distribution (e.g., advertisements), the information can include trends indicating increased views of advertisements at certain times, or trends indicating increased conversions at certain times. The information can include characterizations of datasets that tend to be associated with the domain. For example, if the domain is the analysis of voting trends, the information can include an indication that, in a dataset associated with the domain, certain attributes (i.e., name of individual) are not correlated with the other attributes of the dataset. The information can include any other suitable type of information related to the domain.

Domain knowledge related to the domain with which the dataset 103 is associated can be uploaded to the domain knowledge database 112 by an administrator of the data management system 101. The domain knowledge can be obtained from other datasets associated with the domain. The domain knowledge can be obtained from databases that include data related to events that occur in the domain. The domain knowledge can be obtained from a user of the data management system 101 based on the experience and personal knowledge of the user. The domain knowledge can be obtained from any other suitable source.

A pattern of the received patterns 105 can define statistical information characterizing at least a portion of data in the dataset 103. The statistical information can include any suitable type of statistical information about the dataset 103. The statistical information can be statistical information that is of interest to the data consumer 102. For example, the statistical information can include a number of times a particular datum is included as a particular attribute in the portion of data, such as the number of times the datum of ’20 years old’ is included as the age attribute in a portion of a dataset about individuals. In some examples, the statistical information can include an average of values that represent data included as a particular attribute in the portion of data, such as the average value of the ages of the individuals included in a portion of data of a dataset about individuals. The data used to generate the statistical information can be preserved in the

The data management system 101 identifies a search space including a set of candidate patterns. In some implementations, the search space of candidate patterns can be based on the dataset 103, e.g., some or all of the candidate patterns can be based on the data and/or types of data in the dataset 103. In some implementations, the search space of candidate patterns can include all known patterns. The search space can include candidate patterns that define statistical information characterizing at least a portion of data in the dataset 103, as described above.

The data management system 101 can use domain knowledge from the domain knowledge database 112 to identify the search space. The candidate patterns included in the search space can be patterns corresponding to the domain associated with the dataset 103. For example, a domain associated with a dataset can have one or more types of statistical information with which it corresponds and/or one or more relationships between attributes that are relevant to the domain. The candidate patterns can include each of a set of patterns that define each type of statistical information corresponding with the domain for each attribute included in the dataset. In some examples, the candidate patterns can include each of a set of patterns that define each type of statistical information corresponding with the domain for each possible combination of the attributes included in the dataset.

For example, the one or more types of statistical information corresponding with a domain can include count information (e.g., a count of how many items in the dataset have a particular value for a particular attribute), the mean, the median, the mode, the variance, the standard deviation, quantiles, order statistics, test statistics, and any other suitable type of statistical information. Each of these types of statistical information can be applied to each attribute in a dataset and each possible combination of the attributes in a dataset. The candidate patterns can include, for each type of statistical information applied to each attribute in a dataset and each possible combination of the attributes in a dataset, the pattern that defines the type of statistical information applied to the attribute or combination of attributes.

A domain associated with a dataset can have one or more correlations between attributes in the dataset with which it corresponds. For example, the one or more correlations between attributes corresponding with a domain can include one or more correlations between a first attribute of the dataset and a second attribute of the dataset. The one or more correlations between a first attribute of the dataset and a second attribute can include a count of how many items in the dataset that have a first particular value for the first attribute, have a second particular value for the second attribute. The one or more correlations between a first attribute of the dataset and a second attribute can include a measure of an average amount, among the items included in the dataset, by which a value of the first attribute changes if a value of the second attribute changes by a given amount.

The candidate patterns can be patterns that the data management system 101 has the potential to incorporate into a generated synthetic dataset. In some implementations, the candidate patterns can include the received patterns 105.

The data management system 101 uses the pattern selection engine 104 to select a proper subset of the candidate patterns from the search space. A proper subset of the candidate patterns can be a set of one or more patterns such that each pattern in the set of one or more patterns is one of the candidate patterns in the search space, and such that there is at least one candidate pattern in the search space that is not in the proper subset of one or more patterns. The pattern selection engine 104 can select the proper subset of the candidate patterns using information received from the error computer 106, the weight determination engine 108, and/or the pattern identifier 110. The pattern selection engine 104 can select the proper subset of the candidate patterns using the dataset 103 and the received patterns 105.

In some implementations, the error computer 106 can compute a likelihood that incorporation of one or more patterns of the set of candidate patterns into a synthetic dataset to be generated by the data management system 101 produces an error in a response to a query of the synthetic dataset. The error computer 106 can process the dataset 103 and the received patterns 105 in order to compute the likelihood.

For example, the error computer 106 can determine a quantity of noise that is likely to be added to the dataset 103 in the generation of a synthetic dataset using the dataset 103 that incorporates one or more patterns of the set of candidate patterns. The error computer 106 can determine the quantity of noise based on the number of items about which the dataset 103 includes information. For example, if the dataset 103 includes information about a smaller number of items, the error computer 106 can determine that more noise is likely to be added. If the dataset 103 includes information about a larger number of items, the error computer 106 can determine that less noise is likely to be added.

In some implementations, the error computer 106 can determine the quantity of noise based on the one or more patterns incorporated into the synthetic dataset to be generated. For example, the generation of a synthetic dataset that incorporates some patterns can be likely to involve adding a large quantity of noise to the dataset 103, whereas the generation of a synthetic dataset that incorporates other patterns can be likely to involve adding a small quantity of noise to the dataset 103.

The error computer 106 can determine the quantity of noise based on a target level of differential privacy in the synthetic dataset, e.g., in combination with any of the above parameters. Higher levels of differential privacy often require more noise, but that can differ based on the patterns being preserved and/or the number of data items in the data.

The error computer 106 can use the determined quantity of noise to compute the likelihood that incorporation of one or more patterns of the set of candidate patterns into a synthetic dataset to be generated by the data management system 101 produces an error in a response to a query of the synthetic dataset. For example, the amount of noise added to a dataset in the generation of a synthetic dataset using the dataset can be correlated with a likelihood that a response to a query of the synthetic dataset produces an error. Therefore, if the error computer 106 determines that a large quantity of noise is likely to be added to the dataset 103 in the generation of a synthetic dataset that incorporates the one or more patterns, the error computer 106 can compute a high likelihood that incorporation of the one or more patterns into the synthetic dataset produces an error in a response to a query of the synthetic dataset. If the error computer 106 determines that a small quantity of noise is likely to be added to the dataset 103 in the generation of a synthetic dataset that incorporates the one or more patterns, the error computer 106 can compute a low likelihood that incorporation of the one or more patterns into the synthetic dataset produces an error in a response to a query of the synthetic dataset.

In some implementations, the error computer 106 can compute one or more likelihoods, each likelihood corresponding to a different group of one or more patterns of the set of candidate patterns. Each likelihood of the one or more likelihoods can represent the likelihood that incorporation of the corresponding group of one or more patterns of the set of candidate patterns into a synthetic dataset to be generated by the data management system 101 produces an error (or a higher than acceptable error rate) in a response to a query of the synthetic dataset. For example, preserving some patterns in the synthetic dataset may cause errors in statistics computed based on the overall synthetic dataset.

The error computer 106 can transmit the one or more likelihoods to the pattern selection engine 104. The pattern selection engine 104 can select a proper subset of the candidate patterns from the set of candidate patterns using the one or more likelihoods. For example, the pattern selection engine 104 can select patterns to be included in the proper subset for which the likelihoods that incorporation of the patterns into the synthetic dataset produces an error in a response to a query of the synthetic dataset are below a defined threshold likelihood. This can help to increase a likelihood that the data management system 101 returns an accurate response to a query transmitted to the system by a data consumer related to a synthetic dataset generated by the system.

In some implementations, the pattern selection engine 104 can select patterns to be included in the proper subset using the likelihoods by selecting a specified number of patterns from the set of candidate patterns. For example, the pattern selection engine 104 can select the specified number of patterns such that each selected pattern has a lower likelihood than all of the unselected patterns (e.g., the pattern selection engine 104 can select the specified number of patterns having the lowest likelihoods). For example, if the specified number is 20, the pattern selection engine 104 can select the 20 patterns with the lowest likelihoods from the set of candidate patterns. This can also help to increase a likelihood that the data management system 101 returns an accurate response to a query transmitted to the system by a data consumer related to a synthetic dataset generated by the system.

In some implementations, the weight generation engine 108 assigns to each of one or more patterns in the set of candidate patterns a respective weight. The weight assigned to a pattern can represent a measure of the relevance of the pattern to the domain associated with the dataset 103. The weight generation engine 108 can use domain knowledge related to the domain associated with the dataset from the domain knowledge database 112 to determine the measure of relevance of each of the one or more patterns in the set of candidate patterns to the domain associated with the dataset.

For example, if the domain associated with a dataset is the analysis of voting trends among individuals, the weight generation engine 108 can use knowledge about the domain to determine a measure of the relevance for one or more patterns in the set of candidate patterns. For example, the weight generation engine 108 might determine a high measure of relevance for a pattern that includes statistical information relating to the ages of the individuals whose information is included in the dataset because, in the context of analyzing voting trends among individuals, statistical information about the ages of individuals who voted can be relevant. The weight generation engine 108 can therefore assign a large weight to such a pattern. The weight generation engine 108 might determine a low measure of relevance for a pattern that includes statistical information relation to the names of individuals because, in the context of analyzing voting trends among individuals, the names of individuals who voted can be irrelevant. The weight generation engine 108 can therefore assign a small weight to such a pattern.

In some implementations, the weight generation engine 108 can assign the weights to each of the one or more patterns in the set of candidate patterns using information received from the error computer 106. For example, the weight generation engine 108 can receive from the error computer 106 one or more likelihoods that each represent a likelihood that incorporation of a pattern of one or more patterns of the set of candidate patterns into a synthetic dataset to be generated by the data management system 101 produces an error in a response to a query of the synthetic dataset. The weight generation engine 108 can then assign to each pattern of the one or more patterns a weight that is based on the likelihood received from the error computer 106 that corresponds to the pattern. The weight generation engine 108 can assign to each pattern a weight equal to any suitable combination of the likelihood received from the error computer 106 that corresponds to the pattern and a measure of relevance of the pattern to the domain associated with the dataset.

Assigning weights that combine the likelihood received from the error computer 106 and the measure of relevance determined by the weight generation engine 108 can improve the computational efficiency of the data management system 101. For example, it can reduce a likelihood that the data management system 101 wastes computational resources by generating a synthetic dataset that incorporates irrelevant patterns and/or patterns that result in errors. For example, if the data management system 101 selects a proper subset of patterns to incorporate into the generated synthetic dataset using only likelihoods that incorporation of the patterns produce errors in a response to a query, the data management system 101 can select irrelevant patterns to be included in the proper subset based on the likelihood values of the irrelevant patterns. The data management system 101 can then waste computational resources generating synthetic datasets that incorporate these irrelevant patterns. Assigning weights that combine the likelihood received from the error computer 106 and the measure of relevance determined by the weight generation engine 108 can also improve the quality of the synthetic datasets generated by the data management system 101 by reducing a likelihood that the generated datasets incorporate irrelevant patterns or patterns that are likely to produce errors in a response to a query.

The weight generation engine 108 can transmit the weights assigned to the one or more patterns in the set of candidate patterns to the pattern selection engine 104 to be used in selecting a proper subset of the candidate patterns from the set of candidate patterns. For example, the pattern selection engine 104 can select patterns to be included in the proper subset that have larger weights relative to other patterns of the one or more patterns to which the weight generation engine 108 assigns weights. In some implementations, the pattern selection engine 104 can select, from the one or more patterns to which the weight generation engine 108 assigns weights, a pre-defined number of patterns to which the highest weights are assigned by the weight generation engine 108. The pre-defined number can be any suitable number. For example, the pre-defined number can be based on a maximum number of patterns that the data management system 101 is able to incorporate into a synthetic dataset that it generates. In some implementations, the pre-defined number can be based on the number of received patterns 105 received by the data management system 101. For example, the pre-defined number can be equal to a difference between the maximum number and the number of received patterns 105. The pre-defined number can be equal to a difference between the maximum number and a number of pre-set patterns to be incorporated into the synthetic dataset.

In some implementations, the pattern selection engine 104 can select patterns from the one or more patterns that are assigned weights that are higher than a pre-defined threshold weight. The pre-defined threshold weight can be any suitable weight.

In some implementations, the pattern selection engine 104 can select the proper subset of the candidate patterns by first providing information related to a proposed subset of patterns to the data consumer 102. For example, the pattern selection engine 104 can select a proper subset of the candidate patterns using the techniques described above. This proper subset of the candidate patterns can be a proposed subset of patterns. The proposed subset of patterns can represent a subset of patterns that the data management system 101 can potentially incorporate into a synthetic dataset generated based on the dataset 103 and the received patterns 105. In some implementations, the proposed subset of patterns includes a library of proposed patterns from which the data consumer 102 can select one or more patterns to be incorporated into the generated synthetic dataset.

The information related to the proposed subset of patterns can include information about the accuracy with which a synthetic dataset that incorporates the proposed subset of patterns will represent the information included in the dataset 103. For example, the generation of a synthetic dataset that incorporates the proposed subset of patterns can involve adding noise to the dataset 103 to generate a dataset with added noise. The dataset with added noise can represent the information included in the dataset 103 with limited accuracy. This can impact the accuracy with which the generated synthetic dataset represents the information included in the dataset 103, e.g., by not preserving one or more relations among one or more items or among one or more attributes of the dataset 103, or by resulting in a loss of some of the information included in the dataset 103. Thus, the information related to the proposed subset of patterns can include information characterizing an extent to which the accuracy of the generated synthetic dataset that incorporates the proposed subset of patterns can be impacted due to the addition of noise to the dataset 103.

In response to receiving the information related to the proposed subset of patterns, the data consumer 102 can provide to the data management system 101 feedback related to the proposed subset of patterns. In implementations in which the proposed subset of patterns includes a library of proposed patterns from which the data consumer 102 can select one or more patterns to be incorporated into the generated synthetic dataset, the feedback can include a selection made by the data consumer 102 of one or more patterns in the library of proposed patterns. For example, the data consumer 102 can select the one or more patterns using the information related to the proposed subset of patterns. In implementations in which the information related to the proposed subset of patterns includes information about the accuracy with which a synthetic dataset that incorporates the proposed subset of patterns will represent the information included in the dataset 103, the data consumer 102 can select the one or more patterns using the information about the accuracy, e.g., by selecting patterns the incorporation of which into the generated synthetic dataset is more likely to result in the synthetic dataset representing the information included in the dataset 103 with higher accuracy.

In some implementations, the feedback can include an indication by the data consumer 102 to incorporate one or more patterns into the generated synthetic dataset that were not included in the proposed subset of patterns. In some implementations, the feedback can include an indication by the data consumer 102 not to incorporate one or more patterns that were included in the proposed subset of patterns into the generated synthetic dataset. In some implementations, the feedback can include a rating assigned by the data consumer 102 to each pattern in the proposed subset of patterns. For example, the rating assigned by the data consumer 102 to each pattern can indicate a level of interest of the data consumer 102 in incorporating the pattern into the generated synthetic dataset (e.g., a higher rating can correspond to a higher level of interest).

The pattern selection engine 104 can adjust the proposed subset of patterns using the feedback. In some implementations, the pattern selection engine 104 can generate a second proposed subset of patterns based on the adjustments made using the feedback. The pattern selection engine 104 can then provide the second proposed subset of patterns to the data consumer 102, and in response the data consumer 102 can provide feedback related to the second proposed subset of patterns back to the data management system 101. The pattern selection engine 104 can then adjust the second proposed subset of patterns to generate a

third proposed subset of patterns. In some implementations, this process can be repeated any suitable number of times to generate multiple proposed subsets of patterns. In such implementations, the proper subset of the candidate patterns selected by the pattern selection engine 104 can be the proposed subset of patterns generated on the final iteration of the process.

The pattern selection engine 104 can transmit the selected proper subset of candidate patterns to the synthetic dataset generation engine 114 to be used in generating a synthetic dataset.

In some implementations, the pattern identifier 110 can identify additional patterns not included in the set of candidate patterns. The pattern identifier 110 can identify additional patterns to be incorporated into a synthetic dataset to be generated by the data management system 101 based on the dataset 103 and the received patterns 105.

The pattern identifier 110 can identify the additional patterns using domain knowledge related to the domain associated with the dataset 103. The pattern identifier 110 can access the domain knowledge from the domain knowledge database 112 when identifying the additional patterns. For example, the pattern identifier 110 can determine that one or more patterns not included in the set of candidate patterns are likely to be relevant to the domain associated with the dataset 103. The pattern identifier 110 can identify the additional patterns to be the one or more patterns that are likely to be relevant. The pattern identifier 110 can transmit the identified additional patterns to the synthetic dataset generation engine 114 to be used in generating a synthetic dataset.

The synthetic dataset generation engine 114 can use the proper subset of the candidate patterns that it receives from the pattern selection engine 104 and the additional patterns that it receives from the pattern identifier 110 to generate a synthetic dataset. In some implementations, the synthetic dataset generation engine 114 can generate the synthetic dataset using techniques substantially similar to those described in Cai et. al., “PrivLava: Synthesizing Relational Data with Foreign Keys under Differential Privacy”, Proceedings of the ACM on Management of Data, 2023, which is incorporated herein by reference. In some implementations, the synthetic dataset generation engine 114 can generate the synthetic dataset using techniques substantially similar to those described in Cai et. al., “Data Synthesis via Differentially Private Markov Random Fields”, Proceedings of the VLDB Endowment, Volume 14, Issue 11, 2021, which is incorporated herein by reference. The techniques described in these papers generate synthetic datasets that preserve patterns in the datasets.

For example, the synthetic dataset generation engine 114 can generate the synthetic dataset by first selecting a pattern from either of the proper subset of the candidate patterns or the additional patterns. The synthetic dataset generation engine 114 can then generate a latent variable that characterizes the selected pattern and append the latent variable to the dataset. The latent variable can be an additional attribute that is appended to the dataset. The latent variable can correspond to a group of the attributes included in the dataset 103 such that all items in the dataset 103 for which the value of the latent variable is the same also have the same values for each attribute in the group of attributes.

The synthetic dataset generation engine 114 can then add differential privacy noise to the latent variable that is appended to the dataset. Differential privacy noise can be noise that is added to one or more attributes included in a dataset such that values of one or more outputs obtained by performing calculations on the dataset before the noise is added are separated from values of the one or more outputs obtained by performing the same calculations on the dataset after the noise is added by an amount less than a threshold amount.

The values of the latent variable to which noise has been added by the synthetic dataset generation engine 114 can define a distribution. The synthetic dataset generation engine 114 can then generate an initial synthetic dataset using the distribution. For example, the initial synthetic dataset can include the attributes included in the dataset 103 and the latent variable. The initial synthetic dataset can be generated such that a distribution of the latent variable in the initial synthetic dataset matches the distribution of the values of the latent variable to which noise was added. All items included in the initial synthetic dataset for which the value of the latent variable is the same also have the same values for each attribute of the group of attributes that corresponds with the latent variable. Thus, a joint distribution of the group of attributes in the initial synthetic dataset is likely to be similar to the joint distribution of the group of attributes in the dataset 103.

After generating the initial synthetic dataset, the synthetic dataset generation engine 114 can repeat the operations described above with respect to the initial synthetic dataset. For example, the synthetic dataset generation engine 114 can select a second pattern from either of the proper subset of the candidate patterns or the additional patterns, generate a second latent variable that characterizes the selected second pattern, add noise to the values of the second latent variable, and generate a second synthetic dataset such that a joint distribution of the group of attributes corresponding to the second latent variable in the initial synthetic dataset is likely to be similar to the joint distribution of the group of attributes in the dataset 103, as described above. The synthetic dataset generation engine 114 can repeat these operations any suitable number of times, each time generating a subsequent synthetic dataset as described above. For example, for each iteration of the operations, the synthetic dataset generation engine 114 can generate a subsequent synthetic dataset based on a current synthetic dataset, where the current synthetic dataset is the synthetic dataset generated for the previous iteration. On the final iteration of the operations, the synthetic dataset generation engine 114 can generate a final synthetic dataset.

The synthetic dataset generation engine 114 can select, for each iteration of the operations described above, the pattern from either of the proper subset of the candidate patterns or the additional patterns using any suitable technique. In some implementations, the synthetic dataset generation engine 114 can select the pattern for each iteration of the operations described above by computing an error value with respect to the current dataset corresponding to the iteration for each of the patterns in the proper subset of the candidate patterns and each pattern of the additional patterns. For each pattern, the error value can represent a likelihood that a response to a query of the current dataset related to the pattern produces an error. The synthetic dataset generation engine 114 can then select the pattern for which the error value is the highest.

In some implementations, generating the synthetic dataset includes preserving inter-attribute correlations, intra-group correlations, inter-relational correlations, group size distributions, and/or domain-specific accuracy. For inter-attribute correlations, the techniques can include prioritizing preserving the relationships between different attributes within a single table. These patterns are captured using marginals, which as histograms of subsets of attributes. For example, in a census dataset, this can include the correlation between an individual’s age and income. This can be optimized by using an attribute graph to identify and connect pairs of attributes that are most highly correlations to ensure these patterns are prioritized.

Intra-group correlations deal with relationships between tuples that belong to the same group. The patterns can be captured through latent variables that characterize the composition of a group, as described above and in the PrivLava paper. For example, in a household table, this preserves the pattern of what types of individuals tend to coexist.

Inter-relational correlations represent the dependencies between data across different tables linked by foreign keys. Inferred latent values of tuple groups can be utilized to bridge the generation of primary relations (e.g., households) and secondary relations (e.g., individuals). This can be used to ensure that the synthetic data reflects which types of individuals are likely to reside in specific types of households, such as suburban versus urban households.

The techniques can be used to preserve the statistical distribution of group sizes related to foreign keys. For example, the techniques can be used to estimate and sample from a conditional distribution, which ensures that the number of related records in a secondary table matches the patterns found in the original primary table.

The data management system 101 can be configured to receive a query for information related to the dataset 103 from a data consumer 116. The data consumer 116 can be the same data consumer as the data consumer 102, or the data consumer 116 can be a different data consumer. The query can be for information related to one or more attributes of one or more items included in the dataset 103. The query can be for statistical information characterizing a portion of the dataset 103, such as statistical information defined by a pattern as described above. The query can be for any other suitable type of information related to the dataset 103.

Upon receiving the query, the data management system 101 can use the query handler 118 to process the query. For example, the query handler 118 can process the query to generate a response to the query using data of the generated synthetic dataset. In some implementations, the response to the query generated by the query handler 118 can include information about one or more items included in the synthetic dataset. In some implementations, the response to the query generated by the query handler 118 can include information about one or more attributes of one or more items included in the synthetic dataset. In some implementations, the query handler 118 can perform calculations using the information included in the synthetic dataset, and the response to the query can include results of the calculations.

The data management system 101 can provide the response to the query generated by the query handler 118 to the data consumer 116.

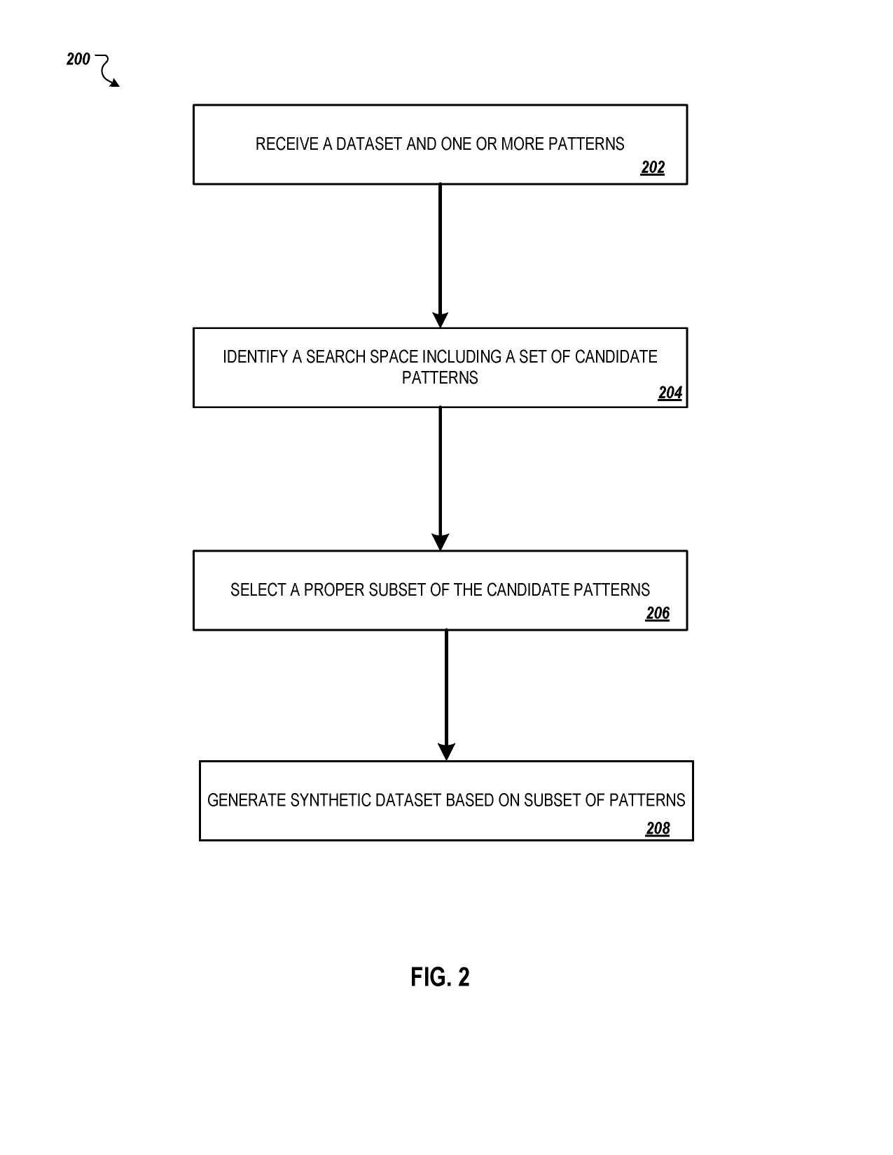

FIG. 2 is a flow diagram of an example process 200 for selecting patterns to be used in generating synthetic datasets. For convenience, the process 200 will be described as being performed by a system of one or more computers located in one or more locations. For example, a data management system, e.g., the data management system 101 depicted in FIG. 1, appropriately programmed in accordance with this specification, can perform the process 200. The operations of the process 200 can also be implemented as instructions stored on a computer readable medium, which can be non-transitory. Execution of the instructions, by one or more data processing apparatus, causes the one or more data processing apparatus to perform operations of the process 200.

The system receives, from a data consumer, a dataset and one or more patterns (202). The dataset can include information about one or more items, each item having one or more attributes. The dataset can be substantially similar to the dataset 103 described with reference to FIG. 1.

Each pattern of the one or more patterns can define statistical information characterizing at least a portion of data in the dataset and/or correlations between attributes or types of data in the dataset. The one or more patterns can be substantially similar to the received patterns 105 described with reference to FIG. 1.

The system identifies a search space including a set of candidate patterns (204). The system can identify the search space based on the dataset received from the data consumer. The candidate patterns can be patterns that the system has the potential to incorporate into a generated synthetic dataset. In some implementations, the candidate patterns can include the one or more patterns received from the data consumer.

In some implementations, the system can use domain knowledge related to a domain associated with the received dataset to identify the search space. For example, the candidate patterns included in the search space can be patterns corresponding to the domain associated with the dataset, as described with reference to FIG. 1.

The system selects a proper subset of the candidate patterns to be used in generating a synthetic dataset (206). The system can select the proper subset of the candidate patterns from the set of candidate patterns included in the search space. The system can use the dataset and the one or more patterns received from the data consumer to select the proper subset.

In some implementations, the system can select the subset of patterns using an error computer included in the system. The error computer can compute likelihoods that incorporation of one or more patterns of the set of candidate patterns into a synthetic dataset to be generated by the system produces an error in a response to a query of the synthetic dataset. For example, the error computer can compute the likelihoods using techniques substantially similar to those described with reference to FIG. 1. The system can select the subset of patterns using the computed likelihoods, e.g., using techniques that are substantially similar to those described with reference to FIG. 1.

In some implementations, the system can select the subset of patterns using domain knowledge related to the domain associated with the dataset. For example, the system can assign to each of one or more patterns in the set of candidate patterns a respective weight, where the respective weight is determined using the domain knowledge. The system can use the assigned weights to select the subset of patterns. For example, the system can assign weights and use them to select the subset of patterns using techniques substantially similar to those described with reference to FIG. 1.

In some implementations, the system can use the domain knowledge to generate additional patterns to be included in the subset of patterns, e.g., using techniques substantially similar to those described with reference to FIG. 1. In some implementations, the system can select the subset of patterns using feedback from a data consumer about a proposed subset of patterns, e.g., using techniques substantially similar to those described with reference to FIG. 1.

In some implementations, after selecting the proper subset of the candidate patterns to be used in generating a synthetic dataset, the system generates a synthetic dataset based on the subset of patterns (208). The system can generate the subset of patterns by adding differential privacy noise to the dataset. For example, the system can add differential privacy noise to a latent variable that characterizes one or more patterns of the subset of patterns. For example, the system can generate the subset of patterns using techniques substantially similar to those described with reference to FIG. 1.

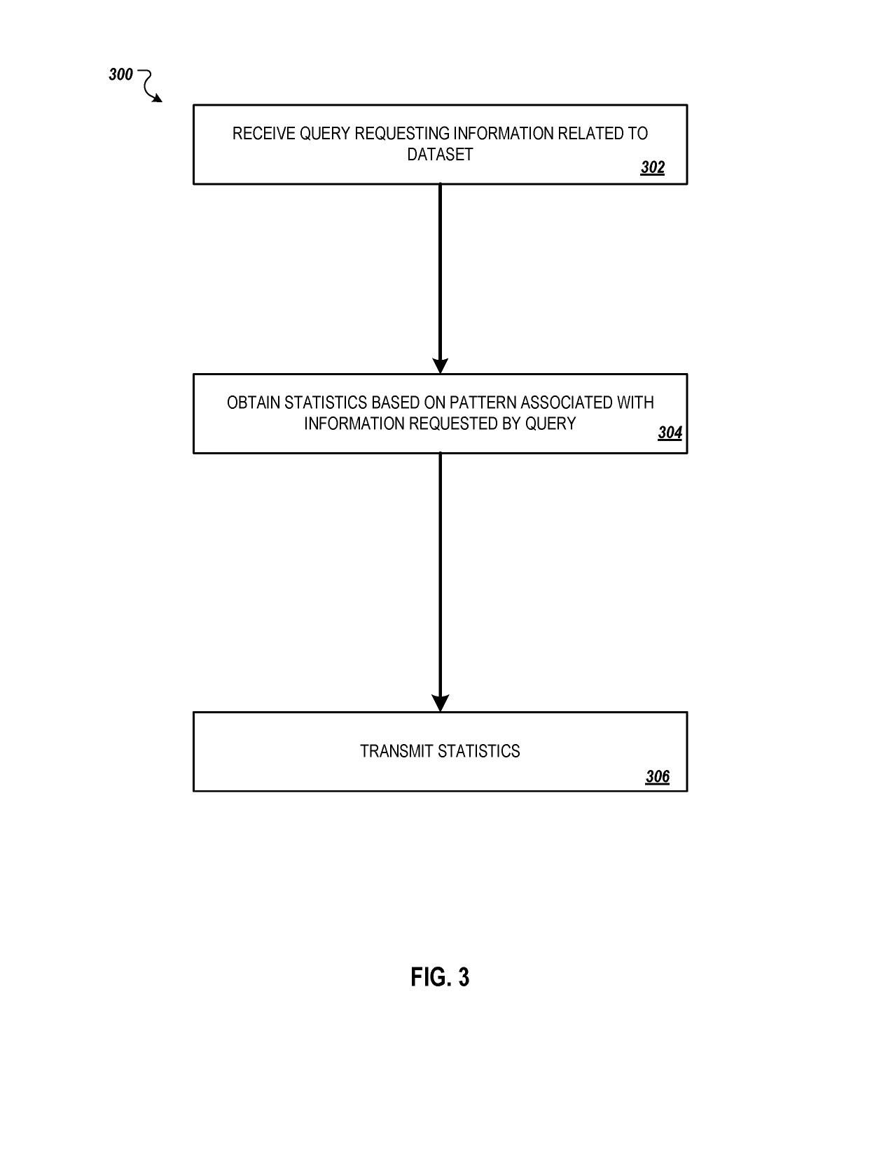

FIG. 3 is a flow diagram of an example process 300 for responding to queries using synthetic datasets. For convenience, the process 300 will be described as being performed by a system of one or more computers located in one or more locations. For example, a data management system, e.g., the data management system 101 depicted in FIG. 1, appropriately programmed in accordance with this specification, can perform the process 300. The operations of the process 300 can also be implemented as instructions stored on a computer readable medium, which can be non-transitory. Execution of the instructions, by one or more data processing apparatus, causes the one or more data processing apparatus to perform operations of the process 300.

The system receives a query requesting information related to a dataset (302). The information can be associated with a pattern of the dataset, where the pattern defines statistical information characterizing at least a portion of the dataset. The system can receive the query from a data consumer.

The system obtains statistics based on the pattern associated with the information requested by the query (304). The system can obtain the statistics using a synthetic dataset that is generated using the process 200 of FIG. 2. The synthetic dataset can have been generated using the process 200 based on the dataset to which the information requested by the query is related. In some implementations, the system can have generated the synthetic dataset that is used to obtain the statistics.

In some implementations, the statistics can include the statistical information defined by the pattern. In some implementations, the statistics can include results of computations performed based on the statistical information defined by the pattern.

The system transmits the obtained statistics (306). The system can transmit the obtained statistics to the data consumer from which the system received the query at step 302.

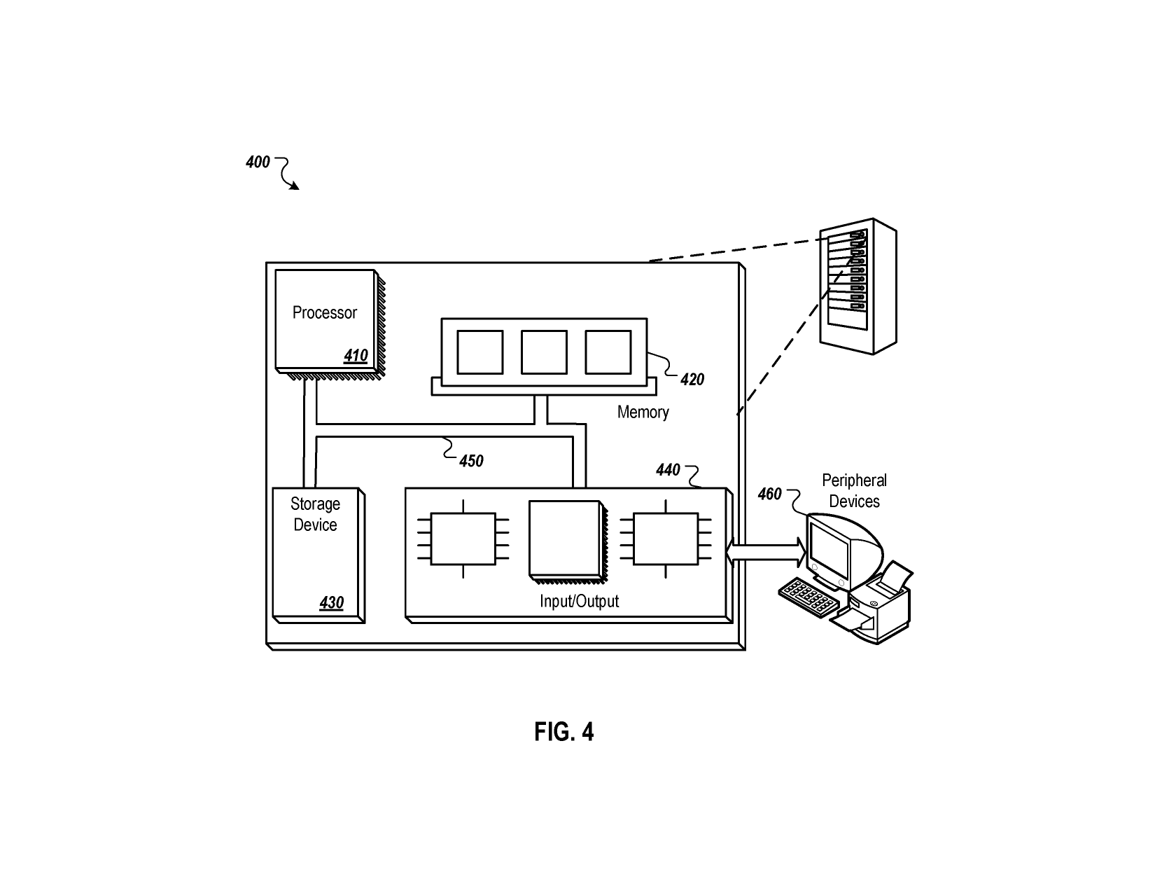

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method performed by one or more computers, the method comprising:
receiving, from a data consumer, a dataset and one or more patterns, wherein each pattern defines statistical information characterizing at least a portion of data in the dataset;
identifying, based on the dataset, a search space comprising a set of candidate patterns;
selecting, using the dataset and the one or more patterns, from the set of candidate patterns, a proper subset of the candidate patterns to be used in generating a synthetic dataset; and
generating a differentially private synthetic dataset based on the subset of patterns.

2. The method of claim 1, wherein generating the differentially private synthetic dataset based on the subset of patterns comprises adding differential privacy noise to a latent variable that characterizes one or more patterns of the subset of patterns.

3. The method of claim 1, comprising:
receiving, from the data consumer, a query for information related to the dataset;
generating a response to the query using data of the synthetic dataset; and
providing, to the data consumer, the response to the query.

4. The method of claim 1, comprising identifying additional patterns not included in the set of candidate patterns using the dataset, wherein generating the synthetic dataset based on the subset of patterns comprises generating the synthetic dataset based on the additional patterns.

5. The method of claim 1, wherein selecting, from the set of candidate patterns, a proper subset of the candidate patterns using the dataset and the one or more patterns comprises selecting the proper subset of the candidate patterns using a likelihood that incorporation of one or more patterns of the set of candidate patterns into the synthetic data set produces an error in a response to a query of the synthetic dataset.

6. The method of claim 1, wherein selecting, from the set of candidate patterns, a proper subset of the candidate patterns using the dataset and the one or more patterns comprises selecting the proper subset of patterns using domain knowledge related to a domain associated with the dataset.

7. The method of claim 1, wherein selecting, from the set of candidate patterns, a proper subset of the candidate patterns using the dataset and the one or more patterns comprises:
providing information related to a proposed subset of patterns to the data consumer;
receiving feedback on the information from the data consumer; and
selecting the proper subset of the candidate patterns using the feedback.

8. The method of claim 1, wherein selecting, from the set of candidate patterns, a proper subset of the candidate patterns using the dataset and the one or more patterns comprises:
assigning to each of one or more patterns in the set of candidate patterns a respective weight based on the set of criteria; and
selecting the proper subset of the candidate patterns using the respective weights.

9. A system comprising:
one or more processors; and
one or more storage devices storing instructions that, when executed by the one or more processors, cause the one or more processors to perform operations comprising:
receiving, from a data consumer, a dataset and one or more patterns, wherein each pattern defines statistical information characterizing at least a portion of data in the dataset;
identifying, based on the dataset, a search space comprising a set of candidate patterns;
selecting, using the dataset and the one or more patterns, from the set of candidate patterns, a proper subset of the candidate patterns to be used in generating a synthetic dataset; and
generating a differentially private synthetic dataset based on the subset of patterns.

10. The system of claim 9, wherein generating the differentially private synthetic dataset based on the subset of patterns comprises adding differential privacy noise to a latent variable that characterizes one or more patterns of the subset of patterns.

11. The system of claim 9, wherein the operations comprise:
receiving, from the data consumer, a query for information related to the dataset;
generating a response to the query using data of the synthetic dataset; and
providing, to the data consumer, the response to the query.

12. The system of claim 9, wherein the operations comprise identifying additional patterns not included in the set of candidate patterns using the dataset, wherein generating the synthetic dataset based on the subset of patterns comprises generating the synthetic dataset based on the additional patterns.

13. The system of claim 9, wherein selecting, from the set of candidate patterns, a proper subset of the candidate patterns using the dataset and the one or more patterns comprises selecting the proper subset of the candidate patterns using a likelihood that incorporation of one or more patterns of the set of candidate patterns into the synthetic data set produces an error in a response to a query of the synthetic dataset.

14. The system of claim 9, wherein selecting, from the set of candidate patterns, a proper subset of the candidate patterns using the dataset and the one or more patterns comprises selecting the proper subset of patterns using domain knowledge related to a domain associated with the dataset.

15. The system of claim 9, wherein selecting, from the set of candidate patterns, a proper subset of the candidate patterns using the dataset and the one or more patterns comprises:
providing information related to a proposed subset of patterns to the data consumer;
receiving feedback on the information from the data consumer; and
selecting the proper subset of the candidate patterns using the feedback.

16. The system of claim 9, wherein selecting, from the set of candidate patterns, a proper subset of the candidate patterns using the dataset and the one or more patterns comprises:
assigning to each of one or more patterns in the set of candidate patterns a respective weight based on the set of criteria; and
selecting the proper subset of the candidate patterns using the respective weights.

17. A non-transitory computer readable storage medium carrying instructions that, when executed by one or more processors, cause the one or more processors to perform operations comprising:
receiving, from a data consumer, a dataset and one or more patterns, wherein each pattern defines statistical information characterizing at least a portion of data in the dataset;
identifying, based on the dataset, a search space comprising a set of candidate patterns;
selecting, using the dataset and the one or more patterns, from the set of candidate patterns, a proper subset of the candidate patterns to be used in generating a synthetic dataset; and
generating a differentially private synthetic dataset based on the subset of patterns.

18. The non-transitory computer readable storage medium of claim 17, wherein generating the differentially private synthetic dataset based on the subset of patterns comprises adding differential privacy noise to a latent variable that characterizes one or more patterns of the subset of patterns.

19. The non-transitory computer readable storage medium of claim 17, wherein the operations comprise:
receiving, from the data consumer, a query for information related to the dataset;
generating a response to the query using data of the synthetic dataset; and
providing, to the data consumer, the response to the query.

20. The non-transitory computer readable storage medium of claim 17, wherein the operations comprise identifying additional patterns not included in the set of candidate patterns using the dataset, wherein generating the synthetic dataset based on the subset of patterns comprises generating the synthetic dataset based on the additional patterns.
